(19) United States
(12) Patent Application Publication
(10) Pub. No.: US 2010/0081382 A1
(43) Pub. Date: Apr. 1, 2010

(54) WIRELESS COMMUNICATION APPARATUS AND WIRELESS COMMUNICATION METHOD

(75) Inventor: Hirokazu Nagashima, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: KABUSHIKI KAISHA TOSHIBA, Tokyo (JP)

(21) Appl. No.: 12/470,042

(22) Filed: May 21, 2009

(30) Foreign Application Priority Data
Sep. 26, 2008 (JP) 2008-248325

(51) Int. Cl. H04B 7/00

(52) U.S. Cl. 455/41.2

(57) ABSTRACT

According to one embodiment, a wireless communication apparatus includes a plurality of communication modules configured to execute wireless communication with an external device, a field strength measurement module configured to measure a field strength from the external device, which is received by each of the plurality of communication modules, a recognition module configured to recognize a movement log of the external device on the basis of a change state of the field strength in each of the plurality of communication modules, which is measured by the field strength measurement module, and a processing module configured to execute a process corresponding to the movement log recognized by the recognition module.

### CROSS-REFERENCE TO RELATED APPLICATIONS

This application is based upon and claims the benefit of priority from Japanese Patent Application No. 2008-248325, filed Sep. 26, 2008, the entire contents of which are incorporated herein by reference.

### BACKGROUND

1. Field

One embodiment of the present invention relates to a technique for executing close-proximity wireless transfer with an external device and more particularly, to a wireless communication apparatus and a wireless communication method which make it possible to recognize the movement of the external device with a plurality of antennas, and perform corresponding processing.

2. Description of the Related Art

In general, a wireless communication apparatus capable of executing close-proximity wireless transfer often performs a process of receiving data from an external device or that of transmitting data to the external device. In this case, the wireless communication apparatus cannot grasp which process the external device wants to perform. For this reason, a process of receiving data from the external device or that of transmitting data to the external device is previously set to be executed. When the external device is detected within a close-proximity wireless transfer range, the previously set process is executed. For example, Jpn. PCT National Publication No. 2003-515839 discloses the following technique. That is, when a token containing encrypted information is brought within the close-proximity wireless transfer range of an electronic device serving as a wireless communication apparatus, a process of permitting access to the electronic device, which has been set in advance, is performed.

The technique described in Jpn. PCT National Publication No. 2003-515839, however, executes a single previously set unilateral process, but cannot select a plurality of processes and bilaterally perform them between the wireless communication apparatus and the external device.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the main components of a multimedia apparatus serving as a wireless communication apparatus according to the first embodiment of the present invention;

FIG. 2 is an exemplary block diagram showing the functional components of the control application of the multimedia apparatus serving as a wireless communication apparatus according to the first embodiment;

FIG. 3 is an exemplary view schematically showing the appearance of the wireless communication apparatus having two antennas according to the first embodiment;

FIG. 4 is an exemplary sequence chart for explaining an outline of a wireless communication method to which the wireless communication apparatus according to the first embodiment is applied;

FIG. 5 is an exemplary flowchart for explaining the wireless communication method to which the wireless communication apparatus according to the first embodiment is applied;

FIG. 6 is an exemplary table schematically showing processes corresponding to gestures, which are used in the wireless communication apparatus according to the first embodiment;

FIG. 7 is an exemplary view for schematically explaining the wireless communication method to which the wireless communication apparatus according to the first embodiment is applied;

FIG. 8 is an exemplary view for schematically explaining the wireless communication method to which the wireless communication apparatus according to the first embodiment is applied;

FIG. 9 is an exemplary view for schematically explaining the wireless communication method to which the wireless communication apparatus according to the first embodiment is applied;

FIG. 10 is an exemplary view for schematically explaining the wireless communication method to which the wireless communication apparatus according to the first embodiment is applied;

FIG. 11 is an exemplary view for schematically explaining a wireless communication method to which a wireless communication apparatus according to the second embodiment of the present invention is applied;

FIG. 12 is an exemplary view for schematically explaining the wireless communication method to which the wireless communication apparatus according to the second embodiment is applied; and

FIG. 13 is an exemplary table schematically showing processes corresponding to gestures, which are used in the wireless communication apparatus according to the second embodiment.

### DETAILED DESCRIPTION

Various embodiments according to the invention will be described hereinafter with reference to the accompanying drawings. In general, according to one embodiment of the invention, a wireless communication apparatus includes: a plurality of communication modules configured to execute wireless communication with an external device; a field strength measurement module configured to measure a field strength from the external device, which is received by each of the plurality of communication modules; a recognition module configured to recognize a movement log of the external device on the basis of a change state of the field strength in each of the plurality of communication modules, which is measured by the field strength measurement module; and a processing module configured to execute a process corresponding to the movement log recognized by the recognition module.

Embodiments of the present invention will be described below with reference to the accompanying drawings.

### First Embodiment

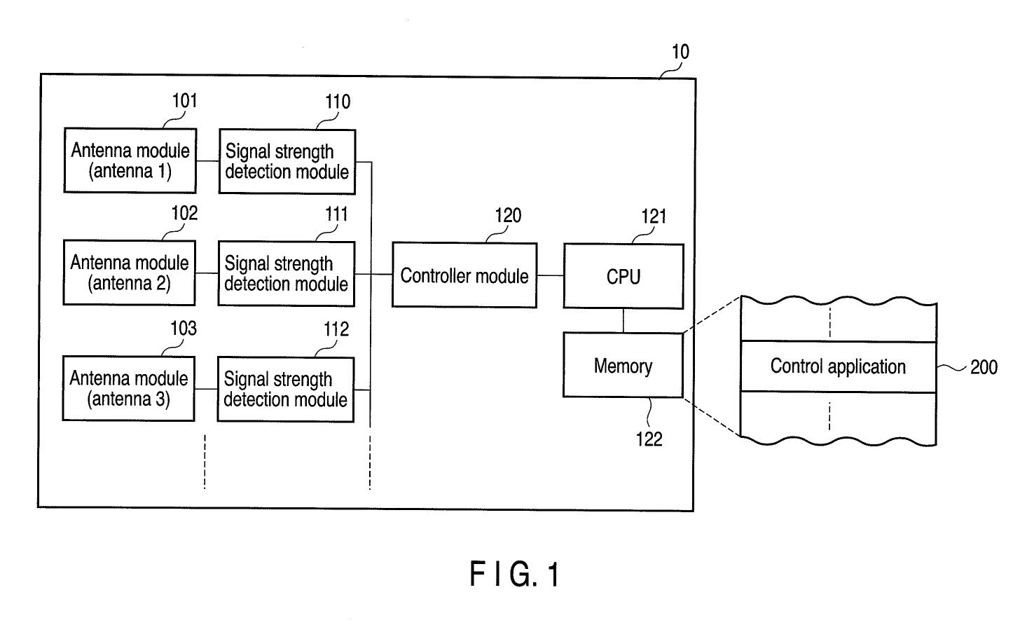

First, the arrangement of a wireless communication apparatus according to the first embodiment of the present invention will be explained with reference to FIG. 1.

This wireless communication apparatus is implemented as, e.g., a multimedia apparatus 10 capable of storing moving images and still images, and outputting them to a television or the like.

FIG. 1 is a block diagram showing the main hardware components of the multimedia apparatus 10. The multimedia apparatus 10 includes a plurality of antenna modules (a plurality of communication modules) 101 (antenna 1), 102 (antenna 2), 103 (antenna 3), . . . , a controller module 120, a CPU 121, and a memory 122.

The antenna module 101, 102, 103, . . . receives a radio signal from an external device capable of executing close-proximity wireless transfer. The close-proximity wireless transfer technique includes a wireless IC tag and TransferJet, but is not limited to them.

Signal strength detection modules 110, 111, 112, . . . are connected to the antenna modules 101, 102, 103, . . . , respectively. The signal strength detection module 110, 111, 112, . . . measures the field strength from the external device capable of executing close-proximity wireless transfer, which has been detected by the corresponding antenna module 101, 102, 103, . . . . The external device capable of executing close-proximity wireless transfer includes, for example, a portable terminal (to be described later) serving as a close-proximity wireless terminal. If, for example, the multimedia apparatus 10 has two antennas, the antenna modules 101 (antenna 1) and 102 (antenna 2) are two-dimensionally arranged on a plane, as shown in FIG. 3.

The controller module 120 receives as signal strength information the field strengths measured by the signal strength detection modules 110, 111, 112, . . . .

The CPU 121 recognizes the movement log of the external device as a gesture on the basis of the signal strength (the field strength: the change state of each field strength) information which has been received by the controller module 120. The CPU 121 also performs control for close-proximity wireless transfer.

The memory 122 stores a control application 200 and information on a gesture corresponding to the change state of each field strength. The CPU 121 loads the control application 200 into the memory 122.

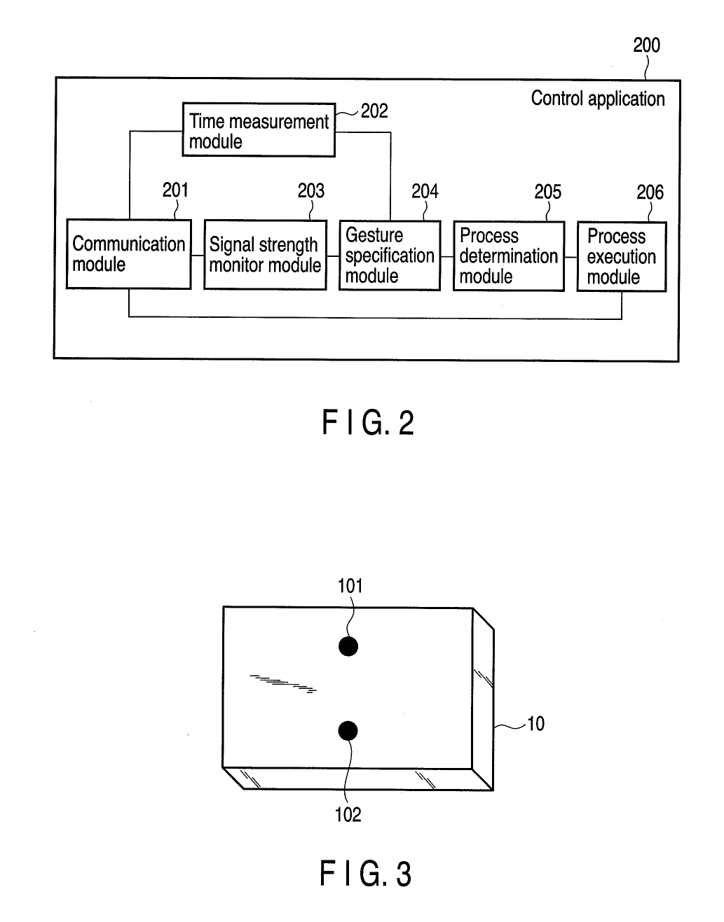

FIG. 2 is a block diagram showing the main functional components of the control application 200.

The control application 200 includes a communication module 201, time measurement module 202, signal strength monitor module (field strength measurement module) 203, gesture specification module (recognition module) 204, process determination module 205, and process execution module (processing module) 206.

The communication module 201 executes a communication process including receiving the signal strength (field strength) information from the controller module 120. Furthermore, the communication module 201 transmits the received signal strength information to the signal strength monitor module 203 (to be described later).

The time measurement module 202 measures an elapsed time. If, for example, a time during which the change amount of the field strength is small is greater than or equal to a predetermined threshold, the gesture specification module 204 determines that the external device is at rest (the device is not in motion=the device has completed its movement). The time measurement module 202 measures the time elapsed until this occurs.

The signal strength monitor module 203 measures the change amount of the signal strength during the elapsed time on the basis of the signal strength information received from the communication module 201.

When the signal strength monitor module 203 measures the change amount of the signal strength during the elapsed time, the gesture specification module 204 specifies the gesture of the external device on the basis of the change amount of the signal strength during the elapsed time. If the time during which the change amount of the field strength is small is greater than or equal to the predetermined threshold, the module 204 determines that the external device is at rest (the device has completed its movement). The movement log of the external device can be obtained by time-serially recording the data from antennas with a strongest field strength.

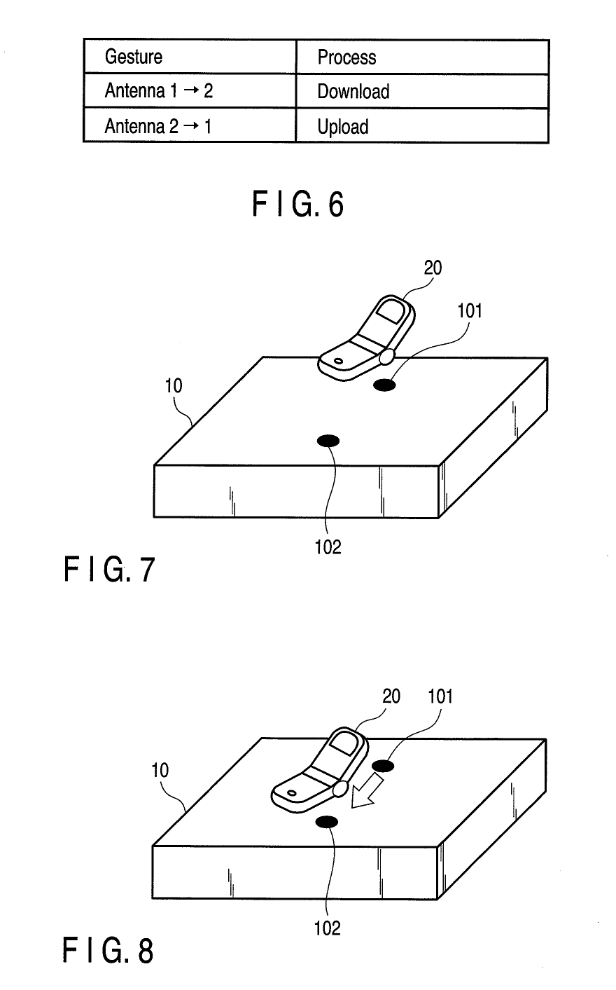

The process determination module 205 reads out from the memory 122 a process corresponding to the gesture specified by the gesture specification module 204, and determines the process. The process corresponding to the gesture includes the following processes, as shown in FIG. 6. If, for example, the movement of the external device is recognized as the gesture of a movement from the antenna module 101 (antenna 1) to the antenna module 102 (antenna 2), data is downloaded from the multimedia apparatus 10 into the external device. If the movement of the external device is recognized as the gesture of a movement from the antenna module 102 (antenna 2) to the antenna module 101 (antenna 1), data is uploaded from the external device to the multimedia apparatus 10.

The process execution module 206 executes the process determined by the process determination module 205.

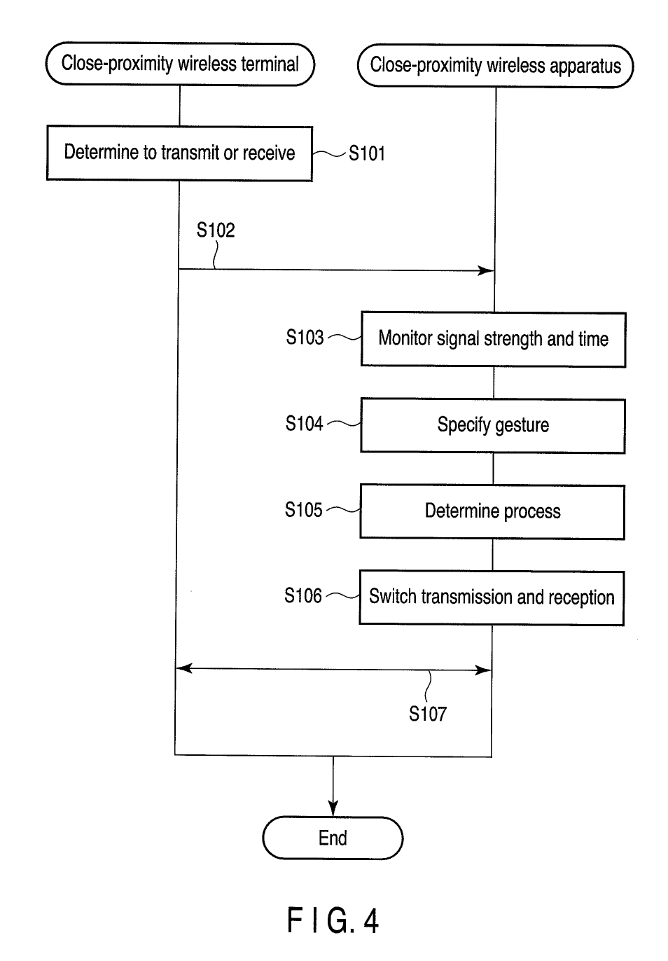

An outline of the processing of a wireless communication method to which the wireless communication apparatus of the present invention with the above-described arrangement is applied will be explained with reference to a sequence chart in FIG. 4. Note that although a case in which the external device transmits/receives data to/from the multimedia apparatus 10 will be described in the this embodiment, the present invention is not limited to this, and various processes can be executed.

When the multimedia apparatus 10 serving as a close-proximity wireless apparatus is activated, the CPU 121 loads the control application 200, and launches activation processing. The control application 200 controlled by the CPU 121 monitors whether a close-proximity wireless terminal serving as an external device is detected within the close-proximity wireless transfer range of the multimedia apparatus 10.

The external device sets whether to transmit (upload) data stored in itself to the multimedia apparatus 10 or to receive (download) data from the multimedia apparatus 10 (block S101). The external device performs a gesture by moving between the antenna module 101 (antenna 1) and the antenna module 102 (antenna 2) (block S102). The multimedia apparatus 10 serving as a close-proximity wireless apparatus measures the field strength from the external device at the antenna module 101 (antenna 1) and the antenna module 102 (antenna 2), and monitors signal strength information and an elapsed time (block S103). The multimedia apparatus 10 specifies (recognizes) the gesture (block S104). The apparatus 10 determines a process corresponding to the specified gesture (block S105: see FIG. 6), and executes the determined process (block S106). The determined process is, for example, a transmission (upload) or reception (download) process. These processes can be switched in accordance with the specified gesture.

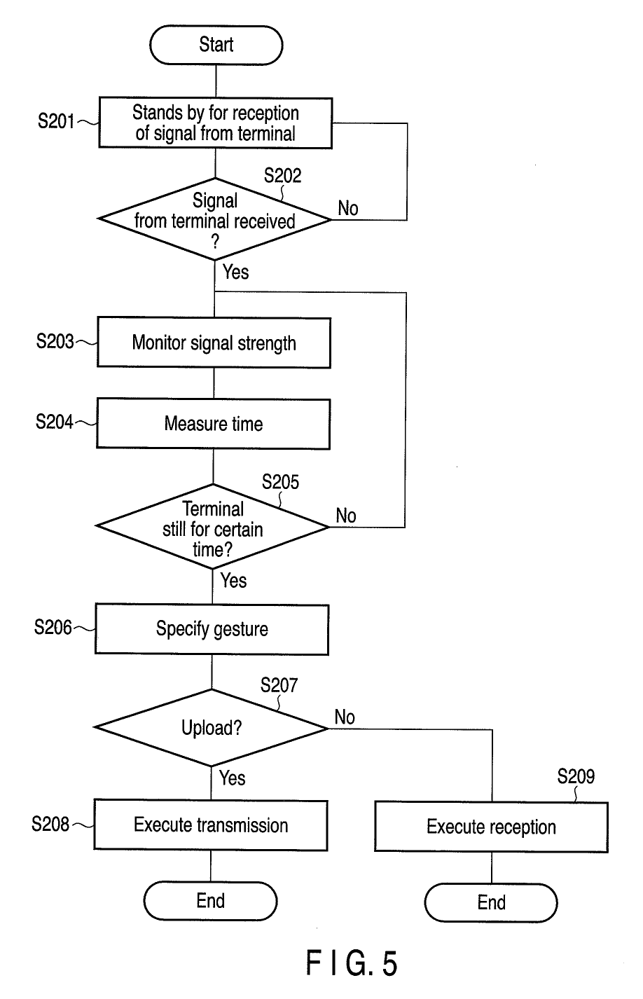

The processing of the above-described wireless communication method will be explained next with reference to a flowchart in FIG. 5. The CPU 121 of the multimedia apparatus 10 stands by for reception of a radio signal from a close-proximity wireless terminal 20 serving as an external device (a field strength monitoring process) (block S201). Upon reception of a radio signal from the close-proximity wireless terminal serving as an external device (YES in block S202), the CPU 121 monitors the signal strength (block S203). That is, the CPU 121 measures the field strength from the external device. If, for example, the close-proximity wireless terminal 20 is brought close to the multimedia apparatus 10 serving as a wireless communication apparatus as shown in FIG. 7, the CPU 121 of the multimedia apparatus 10 receives a signal from the close-proximity wireless terminal 20, and starts monitoring the field strength.

Upon start of the process of monitoring the field strength, the CPU 121 of the multimedia apparatus 10 starts measuring an elapsed time (block S204). If the CPU 121 determines that the close-proximity wireless terminal 20 has remained still for a certain time (a predetermined threshold such as one sec) (YES in block S205), the CPU 121 determines that the gesture of the close-proximity wireless terminal 20 is complete, and starts specifying (recognizing) the gesture of the close-proximity wireless terminal 20 (block S206). If the CPU 121 determines that the gesture of the close-proximity wireless terminal 20 corresponds to an upload process (YES in block S207), the close-proximity wireless terminal 20 transmits (uploads) data to the multimedia apparatus 10 (block S208). Alternatively, if the CPU 121 determines in block S207 that the gesture of the close-proximity wireless terminal 20 corresponds to a download process (NO in block S207), the close-proximity wireless terminal 20 receives (downloads) data from the multimedia apparatus 10 (block S209).

If it is determined that the close-proximity wireless terminal 20 has moved from a position close to the antenna module 101 (antenna 1) (as shown in FIG. 7) to a position close to the antenna module 102 (antenna 2) (as shown in FIG. 8), and then remained still for a certain time, a process of specifying the gesture starts. For the process of specifying the gesture, it is possible to previously set a plurality of processes corresponding to different movements (gestures) of the close-proximity wireless terminal 20, as shown in FIG. 6. If, for example, a movement is recognized as a gesture from the antenna module 101 (antenna 1) to the antenna module 102 (antenna 2), data such as a moving image is downloaded from the multimedia apparatus 10 into the close-proximity wireless terminal 20. The movement log of the close-proximity wireless terminal 20 can be obtained by time-serially recording the data from the antennas with a strongest field strength of the plurality of antennas.

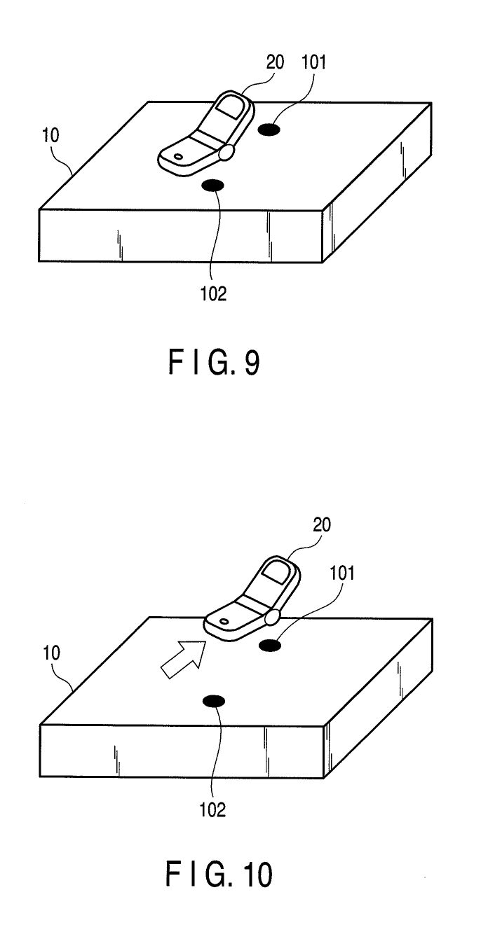

If, for example, it is determined that the close-proximity wireless terminal 20 has moved from a position close to the antenna module 102 (antenna 2) (as shown in FIG. 9) to a position close to the antenna module 101 (antenna 1) (as shown in FIG. 10), and has then remained still for a certain time, the process of specifying the gesture starts. As shown in FIG. 6, for example, if a movement is recognized as a gesture from the antenna module 102 (antenna 2) to the antenna module 101 (antenna 1), data such as a still image is uploaded from the close-proximity wireless terminal 20 to the multimedia apparatus 10. Assume that in recognizing the gesture, if the movement does not match any data (e.g., FIG. 6) of processes corresponding to gestures which have been stored in the memory 122 in advance, that movement is not recognized as a gesture.

According to the above-described first embodiment of the present invention, it is possible to select a plurality of processes, and bilaterally execute them by using close-proximity wireless transfer. Note that the plurality of processes are not limited to those in the above-described embodiment, and it is also possible to perform a process corresponding a gesture as follows. That is, the gesture of the close-proximity wireless terminal 20 is recognized that the terminal 20 has moved from the antenna module 101 (antenna 1) to the antenna module 102 (antenna 2), and again to the antenna module 101 (antenna 1), and has then remained still (has been at rest) for a certain time, a still image may be uploaded from the close-proximity wireless terminal 20 to the multimedia apparatus 10, and then the multimedia apparatus 10 may execute a slideshow of the uploaded still image. As explained above, various processes can be set.

### Second Embodiment

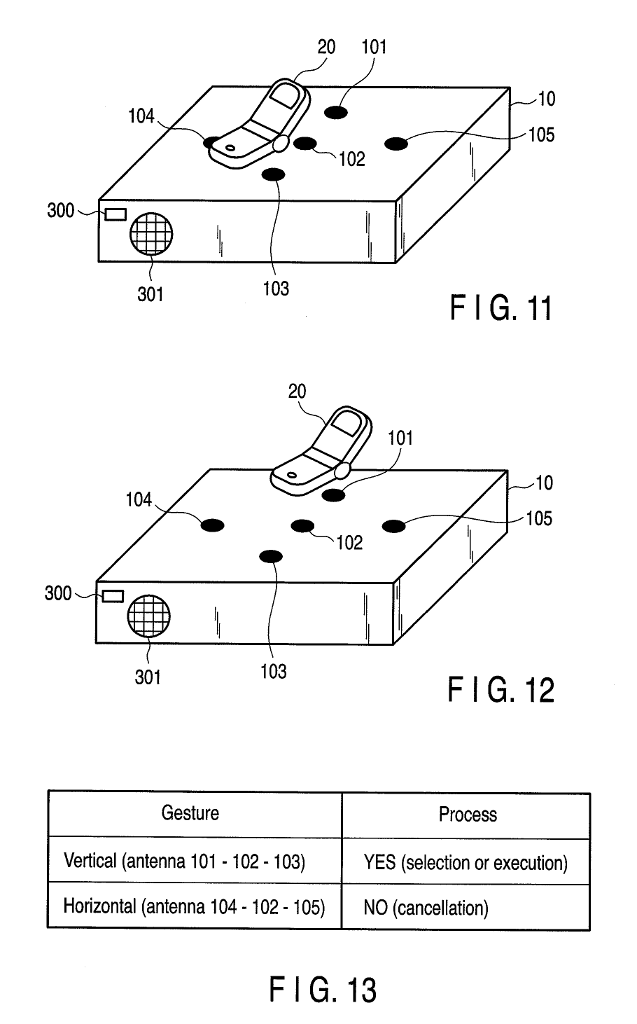

The processing of a wireless communication method to which a wireless communication apparatus according to the second embodiment of the present invention is applied will be explained next with reference to FIGS. 11 and 12.

In the above-described first embodiment, the multimedia apparatus 10 has two antenna modules 101 and 102. In the second embodiment, however, the number of antennas is increased, and a case in which a multimedia apparatus has five antennas will be explained. Note that although the case in which a multimedia apparatus has five antennas will be described in the second embodiment, the number of antennas is not particularly limited and any number of antennas may be used. Various arrangements may also be used. For example, the antennas may be arranged in a ring or matrix topology.

A multimedia apparatus 10 serving as a wireless communication apparatus according to the second embodiment of the present invention has five antennas 101 to 105. These antennas 101 to 105 are arranged in a cross as shown in FIG. 11, for example.

With the antennas 101 to 105 arranged on the multimedia apparatus 10 in a cross topology, if the gesture of a close-proximity wireless terminal 20 is recognized that the terminal 20 has moved from a position shown in FIG. 11 to a position shown in FIG. 12 (this is the movement of the antenna 101-102-103 vertically), a process indicated by YES (selection or execution) is executed. If the gesture of the close-proximity wireless terminal 20 is recognized as the movement of the antenna 104-102-105 horizontally, a process indicated by NO (cancellation) is executed (the process corresponding to the gesture is one of the selection, execution and cancellation processes).

As shown in FIG. 11, the multimedia apparatus 10 also includes an LED 300 serving as an indicator unit and a loudspeaker 301. If, for example, the gesture of the close-proximity wireless terminal 20 is recognized, a CPU 121 of the multimedia apparatus 10 may turn on the LED 300 serving as an indicator unit, or output a recognition completion tone from the loudspeaker 301. Furthermore, if an error occurs in the recognition of the gesture of the close-proximity wireless terminal 20, the CPU 121 may flicker the LED 300 serving as an indicator unit, or output an error tone from the loudspeaker 301.

It is an object of the present invention to provide a wireless communication apparatus and a wireless communication method which make it possible to select a plurality of processes and execute them by using close-proximity wireless transfer.

According to the above-described second embodiment, it is possible to obtain the same effects as in the first embodiment. Furthermore, the indicator unit can clearly indicate the gesture recognition state to the user.

Note that it is possible to accomplish the procedure of the control processing of the embodiments by software. It is therefore possible to readily obtain the same effects as in the embodiments only by installing a program for executing the procedure into a computer through a computer-readable storage medium. The above-described modules can be accomplished as software or hardware. A module can be accomplished in software and hardware.

The present invention is not exactly limited to the above embodiments, and constituent elements can be modified upon practice without departing from the spirit and scope of the invention.

Various inventions can be formed by properly combining a plurality of constituent elements disclosed in the above embodiments. For example, several constituent elements may be omitted from all the constituent elements described in the embodiments. In addition, constituent elements throughout different embodiments may be properly combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a plurality of communication modules configured to wirelessly communicate with an external device;
a radio signal strength measurement module configured to measure a radio signal strength from the external device received by the plurality of communication modules;
a recognition module configured to recognize a trace of the external device based on a change state of the radio signal strength in the plurality of communication modules measured by the radio signal strength measurement module; and
a processor configured to execute a process associated to the trace recognized by the recognition module.

2. The apparatus of claim 1, wherein the recognition module is configured to determine that the external device has stopped when a threshold time has passed since a change of the radio signal strength became substantially small, and to recognize the trace.

3. The apparatus of claim 1, wherein the processor is configured to either transmit data to or receive data from the external device using the communication modules, in accordance with the trace recognized by the recognition module.

4. The apparatus of claim 1, wherein the process associated to the trace is one of selection, execution, and cancellation.

5. The apparatus of claim 1, further comprises an indicator, the indicator configured to indicate when the recognition module recognizes the trace associated to a corresponding process.

6. A wireless communication method used in a wireless communication apparatus which comprises a plurality of communication modules configured to wirelessly communicate with an external device, comprising:
receiving a radio signal from the external device at the plurality of communication modules;
measuring a strength of the received radio signal;
recognizing a trace of the external device based on a change state of the measured radio signal strength in the plurality of communication modules; and
executing a process associated to the recognized trace.

7. The method of claim 6, further comprising determining that the external device has stopped when a threshold time has passed since a change amount of the radio signal strength became substantially small, and recognizing the trace.

8. The method of claim 6, further comprising transmitting data to or receiving data from the external device by using the communication modules, in accordance with the recognized trace.

9. The method of claim 6, wherein the process associated to the trace is one of selection, execution, and cancellation.

10. The method of claim 6, wherein the wireless communication apparatus comprises an indicator configured to indicate when the trace associated to the process is recognized.
